(19) United States
(12) Patent Application Publication
(10) Pub. No.: US 2016/0223368 A1
(43) Pub. Date: Aug. 4, 2016

(54) Sensor Carrier and Sensor

(71) Applicant: Tyco Electronics (Shanghai) Co. Ltd., Shanghai (CN)

(72) Inventor: Wei Yao, Shanghai (CN)

(73) Assignee: Tyco Electronics (Shanghai) Co. Ltd., Shanghai (CN)

(21) Appl. No.: 15/007,715

(22) Filed: Jan. 27, 2016

(30) Foreign Application Priority Data
Jan. 29, 2015 (CN) 201520065377.5

(51) Int. Cl. G01D 11/24

(52) U.S. Cl. CPC G01D 11/245

(57) ABSTRACT

A sensor carrier is disclosed. The sensor carrier includes a carrier housing and a connecting circuit. The carrier housing has a signal detection end and an opposite signal transmission end. The connecting circuit has a main circuit conductive pin, a first branch circuit conductive pin and a second branch circuit conductive pin. A first end of the main circuit conductive pin is connected with a first end of the first branch circuit conductive pin and a first end of the second branch circuit conductive pin. An opposite second end of the main circuit conductive pin extends out of the signal transmission end of the carrier housing. An opposite second end of each of the first and second branch circuit conductive pins is oriented toward the signal detection end, and each is exposed at a different side face of the carrier housing.

### CROSS-REFERENCE TO RELATED APPLICATIONS

This application claims the benefit of the filing date under 35 U.S.C. §119(a)-(d) of Chinese Patent Application No. 201520065377.5, filed Jan. 29, 2015.

### FIELD OF THE INVENTION

The invention relates to a sensor, and more particularly, to a sensor having a sensor carrier.

### BACKGROUND

With regard to various existing sensors (such as a speed or displacement sensor), based on the Hall principle, a chip senses the magnetic field change resulting from the speed change and the displacement change of an object, and the magnetic field change is converted into an electric signal to output the speed and the displacement. The sensor generally includes a carrier, on which a magnet, a chip, and a conductive pin set are mounted. On a known carrier, the chip may only be mounted in one direction.

In practical sensor applications, different customers have different requirements; some customers request a sensor to sense from the end face thereof, while some customers request a sensor to sense from the side face thereof. Two carriers need to be prepared when the chips are mounted for detection in two different directions to meet the different requirements. The necessary production of two different carriers decreases versatility and increases cost.

### SUMMARY

An object of the invention, among others, is to provide a sensor carrier and a sensor that permit a chip to be mounted in different directions. The disclosed sensor carrier includes a carrier housing and a connecting circuit. The carrier housing has a signal detection end and an opposite signal transmission end. The connecting circuit has a main circuit conductive pin, a first branch circuit conductive pin and a second branch circuit conductive pin. A first end of the main circuit conductive pin is connected with a first end of the first branch circuit conductive pin and a first end of the second branch circuit conductive pin. An opposite second end of the main circuit conductive pin extends out of the signal transmission end of the carrier housing. An opposite second end of each of the first and second branch circuit conductive pins is oriented toward the signal detection end, and each is exposed at a different side face of the carrier housing.

### BRIEF DESCRIPTION OF THE DRAWINGS

The invention will now be described by way of example with reference to the accompanying figures, of which:

FIG. 1 is a perspective view of a sensor carrier according to the invention;

FIG. 2 is a perspective view of a sensor carrier according to another embodiment of the invention;

FIG. 3 is a perspective view of a connecting circuit of the sensor carrier shown in FIG. 2;

FIG. 4 is a perspective view of a sensor according to the invention;

FIG. 5 is a side view of a sensor according to the invention;

FIG. 6 is an exploded perspective view of a sensor according to another embodiment of the invention; and

FIG. 7 is a perspective view of a sensor according to another embodiment of the invention.

### DETAILED DESCRIPTION OF THE EMBODIMENT(S)

The invention is explained in greater detail below with reference to embodiments of a sensor and sensor carrier. This invention may, however, be embodied in many different forms and should not be construed as limited to the embodiments set forth herein; rather, these embodiments are provided so that this disclosure will be thorough and complete and still fully convey the scope of the invention to those skilled in the art.

Referring to FIG. 4, the sensor according to the invention comprises a carrier housing 10, a connecting circuit 20, a magnet 30, and a detection chip 40. The major components of the invention will now be described in greater detail.

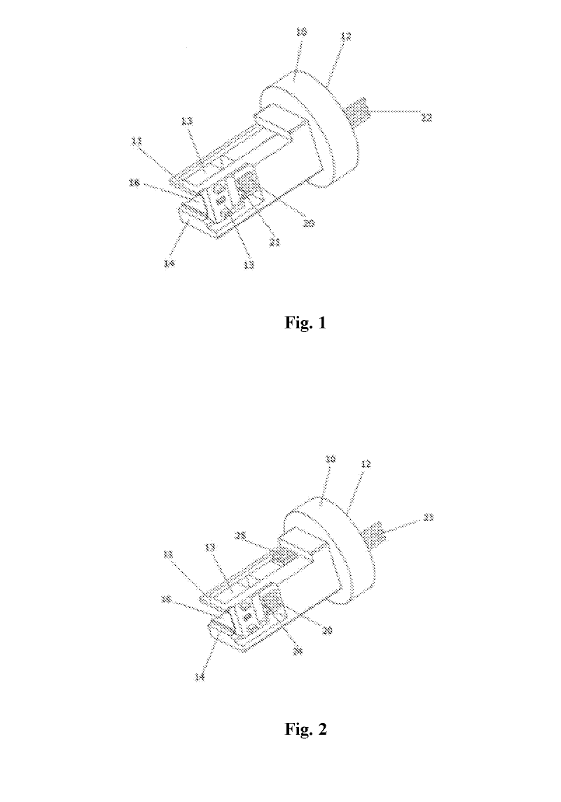

A sensor carrier is formed of housing 10 and connecting circuit 20. The carrier housing 10 is generally made of an insulating material and integrally formed with the connecting circuit 20 through an injection molding process. One end of the carrier housing 10 serves as a signal detection end 11, shown in FIG. 1, while the opposite end of the carrier housing 10 serves as a signal transmission end 12.

As shown in FIG. 1, the connecting circuit 20 comprises an input end 21 and an output end 22; the input end 21 is arranged at the signal detection end 11 of the carrier housing 10 for connecting with a detection chip, and the output end 22 is arranged at the signal transmission end 12 of the carrier housing 10. The carrier housing 10 is provided with a plurality of chip mounting surfaces 13 and 14. A first chip mounting surface 13 is provided at a side face of the signal detection end 11 and a second chip mounting surface 14 is provided at an end face of the signal detection end 11. The carrier housing 10 is provided with a magnet receiving groove 16 for receiving a magnet. The magnet receiving groove 16 is arranged at the signal detection end 11. The magnet receiving groove 16 directly faces the first chip mounting surface 13 and the second chip mounting surface 14.

Referring to FIG. 2, in another embodiment of the sensor carrier, the connecting circuit 20 comprises a main circuit conductive pin 23, a first branch circuit conductive pin 24 and a second branch circuit conductive pin 25, wherein one end of the main circuit conductive pin 23 is connected with one end of the first branch circuit conductive pin 24 and one end of the second branch circuit conductive pin 25, respectively, and the other end of the main circuit conductive pin 23 extends out of the signal transmission end 12 of the carrier housing 10. The other end of the first branch circuit conductive pin 24 and the other end of the second branch circuit conductive pin 25 are respectively exposed at two side faces of the carrier housing 10 and extend towards the signal detection end 11, and can extend along two adjacent side faces or two opposite side faces. The other end of the first branch circuit conductive pin 24 is closer to the signal detection end 11 than the other end of the second branch circuit conductive pin 25. Apart from the extending-out portion of the main circuit conductive pin 23 and the exposed portions of the first and second branch circuit conductive pins 24 and 25, the other portions of the connecting circuit 20 are embedded in the carrier housing 10.

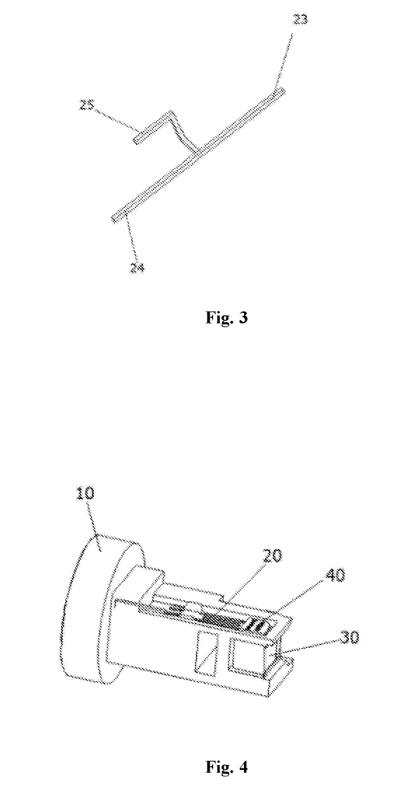

In the specific embodiment shown in FIG. 2, the connecting circuit 20 is provided with three sets of main circuit conductive pins 23, first branch circuit conductive pins 24 and second branch circuit conductive pins 25 arranged in parallel. Referring to FIG. 3, the main circuit conductive pin 23, the first branch circuit conductive pin 24 and the second branch circuit conductive pin 25 in each set are generally formed integrally, wherein the main circuit conductive pin 23 can be formed by linearly extending from the first branch circuit conductive pin 24, and the second branch circuit conductive pin 25 extends by a distance in a direction perpendicular to the first branch circuit conductive pin 24 from the joint of the first branch circuit conductive pin 24 with the main circuit conducive pin 23, and then is bent to extend in a direction parallel to the first branch circuit conductive pin 24, wherein the extending length and the bending times and modes can be selected according to specific requirements. For example, in the embodiment as shown in FIG. 2, in order to respectively expose the other end of the first branch circuit conductive pin 24 and the other end of the second branch circuit conductive pin 25 at two adjacent side faces of the carrier housing 10, the second branch circuit conductive pin 25 firstly extends by a distance in the direction perpendicular to the first branch circuit conductive pin 24, and is bent upwards to extend by a distance, and then is bent to extend in the direction parallel to the first branch circuit conductive pin 24. In addition, when the other end of the first circuit conductive pin 24 and the other end of the second branch circuit conductive pin 25 are respectively exposed at the two opposite side faces of the carrier housing 10, only one bending is required in the middle.

The sensor according to the invention also comprises a magnet 30 and a detection chip 40, as shown in FIG. 4.

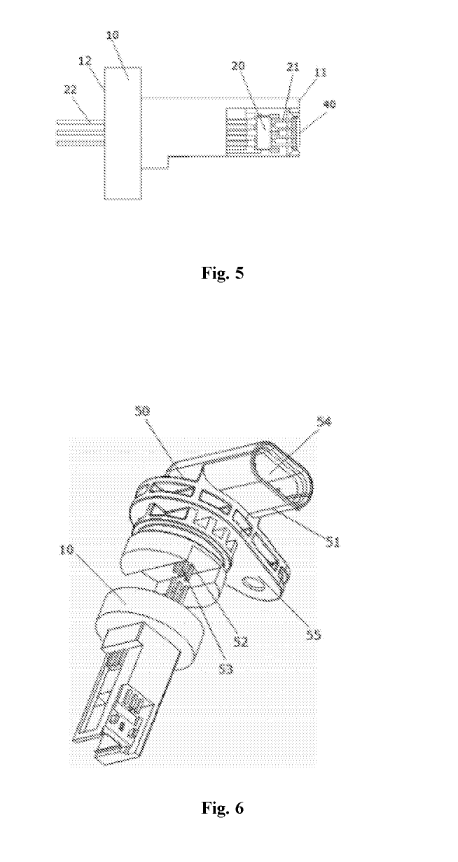

The detection chip 40 is electrically connected with the input end 21 of the connecting circuit; the detection chip 40 can be mounted optionally in two manners; referring to FIG. 4, when the detection chip 40 is mounted on the first chip mounting surface 13 of the carrier housing 10, the detection chip 40 is located on a side face of the signal detection end 11 and electrically connected with the second branch circuit conductive pin 25, such that the sensor senses a signal of the magnet 30 from the side face of the signal detection end 11. Alternatively, referring to FIG. 5, when the detection chip 40 is mounted on the second chip mounting surface 14 of the carrier housing 10, the detection chip 40 is located on an end face of the signal detection end 11 and electrically connected with the first branch circuit conductive pin 24, such that the sensor senses the signal of the magnet 30 from the end face. Thus, with regard to the same sensor carrier and the same detection chip 40, options on two detection directions can be provided to meet the requirements of different customers.

According to the sensor carrier or the sensor of the invention, the connecting circuit 20 may further comprise a protective capacitor (not shown). In a specific embodiment, the protective capacitor is connected between the detection chip 40 and the first branch circuit conductive pin 24 or the second branch circuit conductive pin 25; the protective capacitor can protect the detection chip 40 to prevent damage to the detection chip 40 when a current or a voltage fluctuates seriously in the detection process.

The magnet 30 may be located in the magnet receiving groove 16 of the sensor carrier. The magnet 30 is disposed to directly face the detection chip 40. The polarity direction of the magnet 30 corresponds to the arrangement position of the detection chip 40, that is to say, for the same magnet 30, it can be disposed in such a manner that the polarity thereof is disposed to correspond to the detection chip 40 located on the end face of the signal detection end 11 or in such a manner that the polarity thereof is disposed to correspond to the detection chip 40 located on the side face of the signal detection end 11. The shape of the magnet 30 is preferably a cube, and thus can be fixed in the same magnet receiving groove 16 in the case that the mounting manner is changed.

In a specific embodiment, the sensor according to the invention can be a speed sensor or a displacement sensor; when the sensor gets close to an object to be detected, the speed or displacement change of the object will cause the magnetic field change of the magnet 30 which is converted by the detection chip 40 into a current or voltage signal based on the Hall principle, and the current or voltage signal is transmitted outwards via the output end 22 (the main circuit conductive pin 23) of the connecting circuit 20.

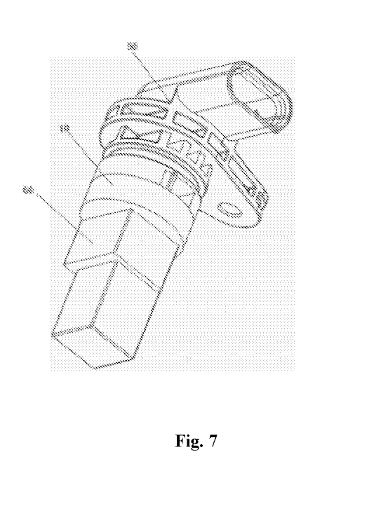

Referring to FIG. 6 and FIG. 7, in another embodiment, the sensor carrier or the sensor according to the invention may further comprise a signal adapter 50.

The signal adapter 50 is provided with an adapter housing 51 and an adapter conductive pin 52 which is located within the adapter housing 51, and the number of the adapter conductive pin 52 is generally consistent with that of the main circuit conductive pin 23 of the connecting circuit 20. The adapter conductive pin 52 is provided with a first end 53 and a second end 54, wherein the first end 53 of the adapter conductive pin is correspondingly electrically connected with the main circuit conductive pin 23 of the connecting circuit 20, while the second end 54 of the adapter conductive pin is used to be electrically connected with an external element. Generally, there are three adapter conductive pins 52 and three main circuit conductive pins 23, wherein one is used for supplying power to the detection chip 40, one is used for transmitting a detection signal outwards, and another one is used for grounding.

In the embodiment as shown in FIG. 6, the first end 53 and the second end 54 of the adapter conductive pin 52 are arranged vertically so as to facilitate connection with the external element. Of course, in other embodiments, the first end and the second end of the adapter conductive pin also can be arranged in a same direction or at other angles. In order to fix the sensor in the using process, the adapter housing 51 can be provided with a mounting plate 55. The mounting plate 55 can be provided with a mounting hole for fixedly mounting with other objects by means of a fastener.

The adapter housing 51 is generally made of an insulating material. In order to firmly combine the adapter housing 51 with the adapter conductive pin 52, the adapter housing 51 and the adapter conductive pin 52 are integrally formed through an injection molding process; the adapter conductive pin 52 can be combined with the adapter housing 51 through the injection molding process before being connected with the main circuit conductive pin 23, or the adapter housing 51 can be formed through the injection molding process after the adapter conductive pin 52 being connected with the main circuit conductive pin 23; in the latter manner, the adapter housing 51 can be injection molded in different length according to the actual need length of the adapter conductive pin 52.

Referring to FIG. 7, the sensor carrier or the sensor according to the invention may further comprise an outer cover 60 which is also generally made of an insulating material. The outer cover 60 covers the periphery of the carrier housing 10 such that the connecting circuit 20, the detection chip 40 and the magnet 30 are all located within the outer cover 60, and thus the influence of the external environment (such as dust, oil stain or gases) on the sensor can be prevented.

Advantageously, according to the sensor carrier and the sensor of the invention, the same sensor carrier and the same detection chip are utilized to provide options on two detection directions to meet the requirements of different customers and applications.

Although the invention is described with reference to the specific embodiments as shown in the accompanying drawings, it should be understood that the sensor carrier and the sensor of the present invention may have many variations without departing from the spirit and the scope taught by the present invention. Various parts in the different specific embodiments in the present invention can be interchanged and re-combined with each other without departing from the spirit and invention taught by the present invention, and the sensor carriers and the sensors obtained in this way also fall within the protection scope of the present invention. It would be also appreciated by those skilled in the art that there are different ways to change the parameters in the disclosed embodiments, such as sizes, shapes, or types of elements or materials, which all fall within the spirit and the scope of the invention and the claims.

What is claimed is:

1. A sensor carrier, comprising:
a carrier housing having a signal detection end and an opposite signal transmission end; and
a connecting circuit having a main circuit conductive pin, a first branch circuit conductive pin and a second branch circuit conductive pin, a first end of the main circuit conductive pin connected with a first end of the first branch circuit conductive pin and a first end of the second branch circuit conductive pin, an opposite second end of the main circuit conductive pin extending out of the signal transmission end of the carrier housing, and an opposite second end of each of the first and second branch circuit conductive pins oriented toward the signal detection end and each exposed at a different side face of the carrier housing.

2. The sensor carrier of claim 1, wherein the carrier housing has a plurality of chip mounting surfaces.

3. The sensor carrier of claim 1, wherein the carrier housing has a first chip mounting surface at a side face of the signal detection end and a second chip mounting surface at an end face of the signal detection end.

4. The sensor carrier of claim 1, wherein the carrier housing has a magnet receiving groove disposed at the signal detection end.

5. The sensor carrier of claim 1, wherein the second branch circuit conductive pin extends in a direction perpendicular to the first branch circuit conductive pin from a point at which the first branch circuit conductive pin connects to the main circuit conducive pin, and also extends in a direction parallel to the first branch circuit conductive pin.

6. The sensor carrier of claim 1, wherein the connecting circuit has three sets of conductive pins arranged in parallel, each set of conductive pins including one main circuit conductive pin, one first branch circuit conductive pin, and one second branch circuit conductive pin.

7. The sensor carrier of claim 6, wherein the main circuit conductive pin, the first branch circuit conductive pin, and the second branch circuit conductive pin in each set are integrally formed.

8. The sensor carrier of claim 1, wherein the carrier housing is integrally formed with the connecting circuit.

9. The sensor carrier of claim 1, further comprising an adapter having an adapter housing and an adapter conductive pin located within the adapter housing, a first end of the adapter conductive pin electrically connected with the main circuit conductive pin and a second end of the adapter conductive pin electrically connected with an external element.

10. A sensor carrier, comprising:
a carrier housing having a signal detection end and an opposite signal transmission end;
a first chip mounting surface at a side face of the signal detection end;
a second chip mounting surface at an end face of the signal detection end; and
a connecting circuit having an input end connected with a detection chip and arranged at the signal detection end of the carrier housing, and an output end arranged at the signal transmission end of the carrier housing.

11. The sensor carrier of claim 10, wherein the carrier housing has a magnet receiving groove disposed at the signal detection end directly facing the first chip mounting surface and the second chip mounting surface.

12. The sensor carrier of claim 10, further comprising an adapter having an adapter housing and an adapter conductive pin located within the adapter housing, a first end of the adapter conductive pin electrically connected with the output end and a second end of the adapter conductive pin electrically connected with an external element.

13. A sensor, comprising:
a sensor carrier, including
a carrier housing having a signal detection end and an opposite signal transmission end; and
a connecting circuit having a main circuit conductive pin, a first branch circuit conductive pin and a second branch circuit conductive pin, a first end of the main circuit conductive pin connected with a first end of the first branch circuit conductive pin and a first end of the second branch circuit conductive pin, an opposite second end of the main circuit conductive pin extending out of the signal transmission end of the carrier housing, and an opposite second end of each of the first and second branch circuit conductive pins oriented toward the signal detection end and each exposed at a different face of the carrier housing; and
a detection chip either located on an end face of the signal detection end and electrically connected with the first branch circuit conductive pin, or located on a side face of the signal detection end and electrically connected with the second branch circuit conductive pin.

14. The sensor of claim 13, further comprising a protective capacitor connected between the detection chip and the first or second branch circuit conductive pin.

15. The sensor of claim 13, further comprising a magnet disposed on the sensor carrier.

16. The sensor of claim 15, wherein the magnet directly faces the detection chip.

17. The sensor of claim 13, further comprising an outer cover covering the periphery of the carrier housing.

18. The sensor of claim 13, wherein the sensor is a speed sensor or a displacement sensor.

19. A sensor, comprising:
a sensor carrier including:
a carrier housing having a signal detection end and an opposite signal transmission end;
a first chip mounting surface at a side face of the signal detection end;
a second chip mounting surface at an end face of the signal detection end; and
a connecting circuit having an input end connected with a detection chip and arranged at the signal detection end of the carrier housing, and an output end arranged at the signal transmission end of the carrier housing; and
a detection chip electrically connected with the input end of the connecting circuit.

20. The sensor of claim 19, further comprising a magnet disposed to directly face the detection chip.
